(19) United States
(12) Patent Application Publication
(10) Pub. No.: US 2007/0241612 A1
(43) Pub. Date: Oct. 18, 2007

(54) Periodically operated windshield wipers system and method

(76) Inventor: Daniel J. Jacoby, Beachwood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/402,717

(22) Filed: Apr. 12, 2006

(51) Int. Cl. B60L 1/00; B60L 3/00

(52) U.S. Cl. 307/9.1

(57) ABSTRACT

Disclosed is a system and method for removing accumulation from a windshield or other glass surface of a vehicle. A Winter Mode is added to the conventional wiper system control level. The Winter Mode is generally activated by a vehicle operator prior to the operator leaving the vehicle. In one embodiment, the invention utilizes a timer control circuit that activates the wiper system periodically. In another embodiment, a sensor for sensing moisture is provided along with a temperature sensor. When moisture is detected on the vehicle window and the temperature is below a particular temperature, the wiper system is activated. In another embodiment a dual mode sensor is provided that includes a moisture sensor and temperature sensor. The wiper system is activated when the dual mode sensor detects moisture and a temperature below a threshold temperature.

### TECHNICAL FIELD OF THE INVENTION

The present invention relates to a system and method for removing accumulation of snow and/or ice from a windshield or other glass surface of a vehicle. More particularly, the invention relates to periodically operating at least one windshield wiper when the vehicle is in the “off” state.

### DESCRIPTION OF THE RELATED ART

Vehicles are generally equipped with at least one set of windshield wipers. Conventional windshield wiper systems can be manually controlled by the operator using a control lever, which is generally located on the base of the steering column. It is common for conventional windshield wiper systems to include multiple wiper settings. Such settings may include, for example, “on”, “off”, and “intermittent”. In the “on” state, the wipers will generally sweep an arc over a predefined area of the windshield at a predetermined rate. In the “off” state, the wipers will generally not move and are located in a location that provides the driver of the vehicle with a substantially unobstructed view out of the windshield. In the “intermittent” state, the wipers will generally sweep an arc over a predefined area of the windshield at a rate manually set by the operator of the vehicle.

Conventional windshield wiper systems may also include an automatic wiper controller that controls the wiper system according to detected physical phenomena (e.g. detection of moisture, adhesion forces, etc.) Generally, an automatic controller includes a detector (e.g., a moisture sensor) and a control circuit coupled to the wiper system to determine if accumulation is falling on the windshield, when the vehicle is in motion, and the wiper system needs to be engaged to assist the operator of the vehicle in viewing through the windshield. Once moisture is detected while the vehicle is in motion, in general operation, the wiper system will automatically activate in order to improve visibility through the windshield.

A problem with conventional windshield wiper systems arises in the winter season. While the wiper system and the moisture sensor are especially crucial to vehicle operators, there is often snow and/or ice build-up on the windshield that substantially decreases the efficiency of such systems. While the industry has made great strides over the years to improve the technology as it relates to the windshield wiper system, the improvements are based on the premise that the vehicle engine is on and/or the vehicle is in motion.

Many times throughout the winter months, people will have a build up of snow and/or ice on the windshield of the vehicle while the car is parked outdoors and turned “off” (i.e., when the vehicle's engine is not operating and/or the vehicle's electrical system is in an “off” state, etc.). During such times, it is common for vehicle operators to manually scrape the snow and/or ice build up off the windshield. However, this process is inconvenient in that the outdoor temperature is very cold and the process takes a significant amount of time. In addition, the process is a major safety concern, since many people tend to scrape off a minimum of visual space needed, so that they can barely view objects through the windshield. By scrapping off the minimum of visual space needed to see out of the windshield, one dramatically limits the visual capacity in the worst of driving conditions. Such practice tends to increase the possibility of an accident above and beyond the snowy and/or icy conditions.

### SUMMARY

A vehicle is most vulnerable to snow and/or ice accumulation when a vehicle is parked outdoors during a snow and/or ice storm. It is desirable to remove accumulation of snow and/or ice prior to the snow and/or ice accumulating on a vehicle. Thus, a strong need exists for a system and method for removing snow and/or ice buildup on a vehicle when the vehicle is in an “off” state (i.e., when the vehicle's motor is not running and/or the vehicle's electrical system is in an “off” state, etc.).

One aspect of the invention relates to a method for removing accumulation of snow and/or ice on a window of a vehicle when the vehicle is in an “off” state, the method comprising: activating a timer that outputs a control signal, wherein the control signal is active for a duration of time; selectively providing power from a power source to a wiper motor corresponding to duration of time the control signal is active, wherein the wiper motor causes one or more wipers to traverse across a vehicle window in a predefined path at a rate.

According to an aspect of the invention, the step of activating is accomplished by an associated user action.

According to an aspect of the invention, the user action is activating a switch on a control lever located in close proximity to an associated vehicle steering wheel.

According to an aspect of the invention, the duration of time is predefined.

According to an aspect of the invention, the duration of time is defined by the user.

According to an aspect of the invention, the power source is battery.

According to an aspect of the invention, the power source is a primary battery for the vehicle.

According to an aspect of the invention, the power source is a dedicated battery for supplying power to the wiper motor.

Another aspect of the invention relates to a method for removing accumulation of snow and/or ice on a window of a vehicle when the vehicle is in an “off” state, the method comprising: detecting an amount of moisture from a moisture sensor; detecting a temperature below a predefined temperature; generating a control signal in response to the steps of detecting a predetermined amount of moisture and detecting a temperature below a predefined temperature, wherein the control signal is active for a duration of time; selectively providing power from a power source to a wiper motor corresponding to duration of time the control signal is active, wherein the wiper motor causes one or more wipers to traverse across a vehicle window in a predefined path at a rate.

According to an aspect of the invention, the predefined temperature is 0° Celsius or less.

According to an aspect of the invention, an outdoor vehicle thermostat is used to accomplish the step of detecting a temperature.

According to an aspect of the invention, the duration of time is predefined.

According to an aspect of the invention, the duration of time is defined by the user.

According to an aspect of the invention, the power source is battery.

According to an aspect of the invention, the power source is a primary battery for the vehicle.

According to an aspect of the invention, the power source is a dedicated battery for supplying power to the wiper motor.

Another aspect of the invention relates to a method for removing accumulation of snow and/or ice on a window of a vehicle when the vehicle is in an “off” state, the method comprising: detecting an amount of moisture on a vehicle window and a temperature of the vehicle window from a dual mode sensor; generating a control signal in response to the steps of detecting a predetermined amount of moisture and detecting a temperature below a predefined temperature, wherein the control signal is active for a duration of time; selectively providing power from a power source to a wiper motor corresponding to duration of time the control signal is active, wherein the wiper motor causes one or more wipers to traverse across a vehicle window in a predefined path at a rate.

According to an aspect of the invention, the predefined temperature is 0° Celsius or less.

According to an aspect of the invention, the duration of time is predefined.

According to an aspect of the invention, the duration of time is defined by the user.

According to an aspect of the invention, the power source is battery.

According to an aspect of the invention, the power source is a primary battery for the vehicle.

According to an aspect of the invention, the power source is a dedicated battery for supplying power to the wiper motor.

Another aspect of the invention relates to a system for removing accumulation of snow and/or ice on a window of a vehicle when the vehicle is in an “off” state, the system comprising: a detector for detecting an amount of moisture on a vehicle window; a temperature sensor for detecting a temperature below a predefined temperature on the vehicle window; a control generated in response to the detector detecting moisture on the vehicle window and the temperature sensor detecting a temperature below a predefined temperature, wherein the control signal is active for a duration of time; a wiper motor selectively powered from a power source when the control signal is active, wherein the wiper motor causes one or more wipers to traverse across the vehicle window in a predefined path at a rate.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary block diagram of a vehicle window wiping system in accordance with aspects of the present invention.

FIG. 2 is an exemplary environmental view in accordance with aspects of the present invention.

FIG. 3 is an exemplary block diagram of a vehicle window wiping system in accordance with aspects of the present invention.

FIG. 4 is an exemplary block diagram of a vehicle window wiping system in accordance with aspects of the present invention.

### DETAILED DESCRIPTION OF EMBODIMENTS

The present invention is directed to a system and method for removing accumulation of snow and/or ice on a window of a vehicle when the vehicle is in an “off” state.

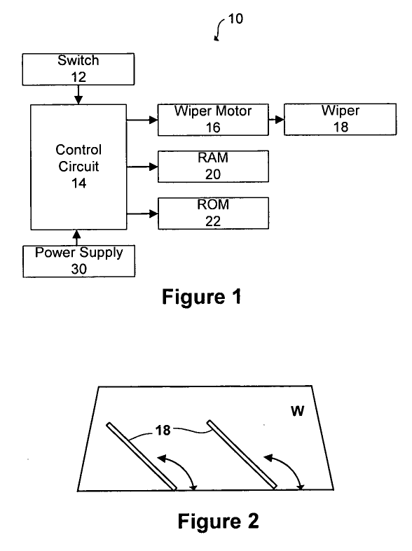

A vehicle wiper control system 10 in accordance with aspects of the present invention is illustrated in FIG. 1. The system 10 includes a wiper switch 12, a control circuit 14, a wiper motor 16, at least one wiper 18, and optionally a random access memory (RAM) 20 and ROM 22.

The wiper switch 12 generates operation signals and outputs the operation signals to the control circuit 14 thereby to direct the wiper motor 16 to operate in one or more respective operation modes according to switching operations. The operation modes may include a stop mode, an automatic mode, an intermittent mode, a low speed mode, a high speed mode or the like, and a Winter Mode. One of ordinary skill in the art will readily appreciate that the various modes, for example, the stop mode, an automatic mode, an intermittent mode, a low speed mode, a high speed mode are self explanatory. One aspect of the invention relates to operation of the vehicle wiper control system in the Winter Mode.

The Winter Mode, as used herein, refers to the removal of snow and/or ice build up on one or windows of an associated vehicle, while the vehicle engine is an off state. As discussed herein, there are various methods of carrying out the present invention.

The control circuit 14 is implemented by a conventional microcomputer and controls the wiper motor 16 by the operational signals to operate in one of the above modes instructed by the wiper switch 12. Unless otherwise stated, the operation of the vehicle wiper control system 10 will be described with the switch 12 in the Winter Mode and the vehicle engine is in an off state.

In one embodiment, the switch 12 is located on a wiper control lever that generally is located near the steering wheel of the vehicle. After the vehicle operator turns off the vehicle engine, the operator will have the ability to activate the Winter Mode system by moving the switch 12 into an appropriate Winter Mode activation position. This action may be done before the operator leaves the vehicle. Once activated, the wipers 18 will automatically move at the preset Winter Mode frequency or at a user defined frequency. The frequency values for the Winter Mode may be stored in RAM 20, ROM 22 and/or control circuit 14.

By entering the Winter Mode, the operator activates a timer function in the control circuit 14. The control circuit 14 may be a time delay relay. One exemplary time delay relay is commercially available from Newark Electronics. The wiper motor 16 receives power from a power source 30 that powers the wipers to sweep across the window W of the vehicle in a predetermined path at a particular wiper frequency, as illustrated in FIG. 2. The power source 30 may be a dedicated power source that is preferably rechargeable and/or the primary power source of the vehicle (e.g., the primary battery of the vehicle). Under such circumstances, the power source (e.g., a dedicated power source, vehicle's primary power source, etc.) would not be constantly powering the wiper motor and therefore would not be subjected to unnecessary draining. Preferably, the power source 30 would only provide a charge for a period of time in which the control signal is activated.

In this embodiment, the operator of the vehicle may manually change the switch 12 on the control lever from the Winter Mode back to a normal operating mode. Preferably, the user changes the switch 12 on the control lever just prior to or after the operator turns the vehicle engine to the “on” state.

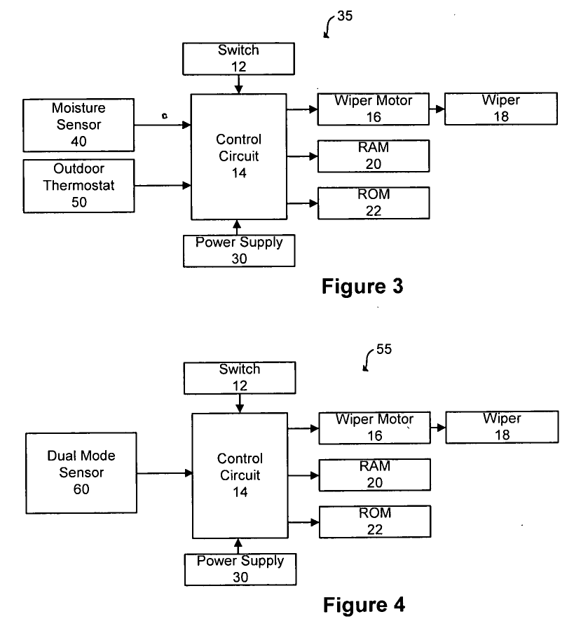

Another embodiment of vehicle wiper control system 35 is illustrated in FIG. 3. Referring to FIG. 3, the vehicle wiper control system 35 includes a sensor 40 for detecting moisture and an outdoor vehicle thermostat 50. In this embodiment, sensor 40 for detecting moisture and outdoor vehicle thermostat 50 are coupled to control system 35. Assuming the vehicle is in an “off” state and after the operator of the vehicle turns the control lever switch 12 to the Winter Mode, the moisture sensor 40 and the outdoor vehicle thermostat will activate. As one of ordinary skill in the art will readily appreciate, the fact that the sensor 40 and thermostat 50 are “activated” does not necessarily mean that the wiper motor is activated. Activation of the sensor 40 and the outdoor vehicle thermostat 50 simply means the detection functions provided by each of the devices are operable (e.g., working independently of each other).

The embodiment illustrated by FIG. 3 requires a series of two independent events to occur in order for the wiper motor 16 and wipers 18 to be activated. The sensor 40 must detect moisture on the windshield W and the outdoor vehicle thermostat 50 must register and/or detect a temperature below a predetermined and/or user specified temperature. The temperature may be predefined or user defined. Preferably, the temperature is substantially 0° Celsius or below. Once both conditions are met (e.g., moisture is detected and the detected temperature is below a certain temperature), a control signal is generated, wherein the control signal is active for a duration of time. The duration of time the control signal is activated may be predefined and/or user specified. Upon generation of the control signal, power is then provided from power source 30 to the wiper motor 16 corresponding to the duration of time the control signal is active. In turn, the wiper motor 16 causes one or more wipers 18 to traverse across a vehicle window W in a predefined path at a rate. As stated above, the rate may be a predefined rate and/or a user defined rate.

If one of the above conditions are no longer met (e.g., the temperature rises above the selected temperature and/or no moisture is detected by the sensor 40), the Winter Mode will become disabled and the wipers 18 will cease operation. The criterion discussed above is selected based on the following design considerations. First, if there is moisture detected but the temperature is above freezing, there would be no snow and/or ice build up on the window W of the vehicle. Secondly, if it is below the freezing temperature, but no moisture is detected, there would also be no snow and/or ice build-up on the Window W. An advantage of this method is that if the weather improves while the vehicle is in the “off” state the Winter Mode system will cease operation of the wiper motor 16, which preserves the life of the power source 30 and wipers 18.

Another embodiment of vehicle wiper control system 55 is illustrated in FIG. 4. Referring to FIG. 4, the vehicle wiper control system includes a dual mode sensor 60 for detecting moisture and window temperature. In this embodiment, dual mode sensor 60 detects moisture on the window W and the temperature of the window W. Assuming the vehicle is in an “off” state and the operator of the vehicle turns the control lever switch 12 to the Winter Mode, the dual mode sensor 60 is activated. As one of ordinary skill in the art will readily appreciate, the fact that the dual mode sensor 60 is “activated” does not necessarily mean that the wiper motor is activated. Activation of the dual mode sensor 60 simply means the dual detection functions provided by the sensor 60 are operational. The operation of the vehicle wiper control system 55 is generally identical with the operation of the wiper control system 45, except that a dual mode sensor 60 is used rather than sensors 40 and 50.

One of ordinary skill in the art will readily appreciate that safety and operational safeguards may be implemented to ensure operational safety, as well mechanical integrity. For example, a mechanism in the control circuit 14 may be implemented to deactivate the entire Winter Mode system. For example, if the wipers 18 encounter a predetermined amount of resistance as one or more of the wipers 18 sweep across the window W due to a snow and/or ice build up, the system may be deactivated. Deactivating the system in this circumstance would reduce chances of wiper damage. In addition, if the power source reaches a certain level (e.g., less than 30% of normal operating power), the system may be deactivated. This would ensure that the power source 30 would not be drained in the event of an extended weather condition and/or inoperable circumstance.

Likewise, it may be desirable to provide additional circuitry to ensure that the power source 30 is not inadvertently drained by including a general purpose relay for low voltage shut-off and/or a zener diode across the terminals of the power source 30. One of ordinary skill in the art will readily appreciate that there are many ways to prevent inadvertent loss of power and/or current from the power source 30.

In addition, while the embodiments described above describe manually activating switch 12 to the Winter Mode, it is within the scope of the present invention that the Winter Mode will be activated automatically by the control circuit 14 under appropriate circumstances. Such circumstance may include, for example, when moisture is detected on the window of the vehicle or any other portion of the vehicle and the outdoor temperature and/or a portion of the vehicle is near or below 0° Celsius.

Specific embodiments of an invention are disclosed herein. One of ordinary skill in the art will readily recognize that the invention may have other applications in other environments. In fact, many embodiments and implementations are possible. The following claims are-in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A method for removing accumulation of snow and/or ice on a window of a vehicle when the vehicle is in an “off” state, the method comprising:
activating a timer that outputs a control signal, wherein the control signal is active for a duration of time;
selectively providing power from a power source to a wiper motor corresponding to duration of time the control signal is active, wherein the wiper motor causes one or more wipers to traverse across a vehicle window in a predefined path at a rate.

2. The method of claim 1, wherein the step of activating is accomplished by an associated user action.

3. The method of claim 2, wherein the user action is activating a switch on a control lever located in close proximity to an associated vehicle steering wheel.

4. The method of claim 1, wherein the duration of time is predefined

5. The method of claim 1, wherein the duration of time is defined by the user.

6. The method of claim 1, wherein the power source is battery.

7. The method of claim 6, wherein the power source is a primary battery for the vehicle.

8. The method of claim 6, wherein the power source is a dedicated battery for supplying power to the wiper motor.

9. A method for removing accumulation of snow and/or ice on a window of a vehicle when the vehicle is in an “off” state, the method comprising:
detecting an amount of moisture from a moisture sensor;
detecting a temperature below a predefined temperature;
generating a control signal in response to the steps of detecting a predetermined amount of moisture and detecting a temperature below a predefined temperature, wherein the control signal is active for a duration of time;
selectively providing power from a power source to a wiper motor corresponding to duration of time the control signal is active, wherein the wiper motor causes one or more wipers to traverse across a vehicle window in a predefined path at a rate.

10. The method of claim 9, wherein the predefined temperature is 0° Celsius or less.

11. The method of claim 10, wherein an outdoor vehicle thermostat is used to accomplish the step of detecting a temperature.

12. The method of claim 9, wherein the duration of time is predefined

13. The method of claim 9, wherein the duration of time is defined by the user.

14. The method of claim 9, wherein the power source is battery.

15. The method of claim 14, wherein the power source is a primary battery for the vehicle.

16. The method of claim 14, wherein the power source is a dedicated battery for supplying power to the wiper motor.

17. A method for removing accumulation of snow and/or ice on a window of a vehicle when the vehicle is in an “off” state, the method comprising:
detecting an amount of moisture on a vehicle window and a temperature of the vehicle window from a dual mode sensor;
generating a control signal in response to the steps of detecting a predetermined amount of moisture and detecting a temperature below a predefined temperature, wherein the control signal is active for a duration of time;
selectively providing power from a power source to a wiper motor corresponding to duration of time the control signal is active, wherein the wiper motor causes one or more wipers to traverse across a vehicle window in a predefined path at a rate.

18. The method of claim 17, wherein the predefined temperature is 0° Celsius or less.

19. The method of claim 17, wherein the duration of time is predefined.

20. The method of claim 17, wherein the duration of time is defined by the user.

21. The method of claim 17, wherein the power source is battery.

22. The method of claim 21, wherein the power source is a primary battery for the vehicle.

23. The method of claim 21, wherein the power source is a dedicated battery for supplying power to the wiper motor.

24. A system for removing accumulation of snow and/or ice on a window of a vehicle when the vehicle is in an “off” state, the system comprising:
a detector for detecting an amount of moisture on a vehicle window;
a temperature sensor for detecting a temperature below a predefined temperature on the vehicle window;
a control signal generated in response to the detector detecting moisture on the vehicle window and the temperature sensor detecting a temperature below a predefined temperature, wherein the control signal is active for a duration of time;
a wiper motor selectively powered from a power source when the control signal is active, wherein the wiper motor causes one or more wipers to traverse across the vehicle window in a predefined path at a rate.
